(19) United States
(12) Patent Application Publication
(10) Pub. No.: US 2025/0045054 A1
(43) Pub. Date: Feb. 6, 2025

(54) METHOD AND ELECTRONIC DEVICE WITH NON-LINEAR FUNCTION

(71) Applicants: SAMSUNG ELECTRONICS CO., LTD., Suwon-si (KR); POSTECH Research and Business Development Foundation, Pohang-si (KR)

(72) Inventors: Jin HYUN, Pohang-si (KR); Youngjoo LEE, Pohang-si (KR); Seungwoo HONG, Pohang-si (KR)

(73) Assignees: SAMSUNG ELECTRONICS CO., LTD., Suwon-si (KR); POSTECH Research and Business Development Foundation, Pohang-si (KR)

(21) Appl. No.: 18/781,624

(22) Filed: Jul. 23, 2024

(30) Foreign Application Priority Data
Aug. 1, 2023 (KR) 10-2023-0100434

(51) Int. Cl. G06F 9/30

(52) U.S. Cl. CPC G06F 9/30149; G06F 9/3001

(57) ABSTRACT

A processor-implemented method includes determining a first width, the first width being a minimum width of a plurality of sectors into which an input range for a non-linear function is divided, and a plurality of second widths dividing the plurality of sectors each into one or more segments, determining a final width of a target sector, the target sector being one of the plurality of sectors, for approximating the non-linear function, based on one or more among the first width and the plurality of second widths, and dividing the non-linear function into one or more segments comprised in the target sector and approximating the divided non-linear function for each of the one or more segments to a linear function.

### CROSS-REFERENCE TO RELATED APPLICATIONS

This application claims the benefit under 35 USC § 119 (a) of Korean Patent Application No. 10-2023-0100434, filed on Aug. 1, 2023 in the Korean Intellectual Property Office, the entire disclosure of which is incorporated herein by reference for all purposes.

### BACKGROUND

### 1. Field

The following description relates to a method and electronic device with a non-linear function.

### 2. Description of Related Art

The operations of a non-linear function on hardware may be used to efficiently process an operation, such as image signal processing, of passing an input value through a non-linear function. Among approximation methods for processing a non-linear function in hardware, a method of dividing sections of a non-linear function, linearly approximating the divided sections, and deriving an operation result may be used.

A non-linear function may include a quadratic function, an exponential function, or a logarithmic function. However, other than said functions, functions in which a relationship between input variables and output variables is not linear and the output variables do not increase or decrease at a certain rate according to an increase or decrease of the input variables may all be classified into the non-linear function.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: determining a first width, the first width being a minimum width of a plurality of sectors into which an input range for a non-linear function is divided, and a plurality of second widths dividing the plurality of sectors each into one or more segments; determining a final width of a target sector, the target sector being one of the plurality of sectors, for approximating the non-linear function, based on one or more among the first width and the plurality of second widths; and dividing the non-linear function into one or more segments comprised in the target sector and approximating the divided non-linear function for each of the one or more segments to a linear function.

The determining the final width of the target sector may include: determining the final width of the target sector to be a multiple of the first width; and determining a width of the one or more segments comprised in the target sector to be one of the plurality of second widths.

The determining the final width of the target sector further may include: dividing the non-linear function into the plurality of second widths and approximating the divided non-linear function to a plurality of linear functions; determining errors of the plurality of linear functions; and determining the final width of the target sector and the width of the one or more segments comprised in the target sector, based on a comparison between an error of a linear function approximated to a greatest second width among the plurality of second widths and a preset error among the errors of the plurality of linear functions.

The determining the final width of the target sector and the width of the one or more segments comprised in the target sector, based on the comparison between the error of the linear function approximated to the greatest second width and the preset error among the errors of the plurality of linear functions, may include determining the final width of the target sector and the width of the one or more segments to be greater as the preset error increases.

The first width and the plurality of second widths are determined in a power of 2, and the plurality of second widths is determined to be less than or equal to the first width.

The number of the one or more segments comprised in the target sector corresponds to a power of 2.

In response to the target sector comprising two or more segments, the two or more segments may be determined to have a same width, and the width of the two or more segments may correspond to a power of 2.

The method may include generating a first look-up table (LUT) comprising mapping information on which a sector among the plurality of sectors may include an input value in response to the input value being input to the non-linear function.

The method may include generating a plurality of second look-up tables (LUTs) corresponding one-to-one to the plurality of sectors, wherein each of the plurality of second LUTs may include a difference between a start function value and an end function value of a linear function approximated for each of one or more segments comprised in a sector corresponding to each second LUT and mapping information on the start function value.

In one or more general aspects, a non-transitory computer-readable storage medium stores instructions that, when executed by a processor, configure the processor to perform any one, any combination, or all of operations and/or methods described herein.

In one or more general aspects, an electronic device includes: one or more processors configured to: determine a first width, the first width being a minimum width of a plurality of sectors into which an input range for a non-linear function is divided, and a plurality of second widths dividing the plurality of sectors each into one or more segments; determine a final width of a target sector, the target sector being one of the plurality of sectors, for approximating the non-linear function, based on one or more among the first width and the plurality of second widths; and divide the non-linear function into one or more segments comprised in the target sector and approximate the divided non-linear function for each of the one or more segments to a linear function.

For the determining the final width of the target sector, the one or more processors may be configured to: determine the final width of the target sector to be a multiple of the first width; and determine a width of the one or more segments comprised in the target sector to be one of the plurality of second widths.

For the determining the final width of the target sector, the one or more processors may be configured to: divide the non-linear function into the plurality of second widths and approximate the divided non-linear function to a plurality of linear functions; determine errors of the plurality of linear functions; and determine the final width of the target sector and the width of the one or more segments comprised in the target sector, based on a comparison between an error of a linear function approximated to a greatest second width among the plurality of second widths and a preset error among the errors of the plurality of linear functions.

The first width and the plurality of second widths may be determined in a power of 2, and the plurality of second widths is determined to be less than or equal to the first width.

The number of the one or more segments comprised in the target sector may correspond to a power of 2.

In response to the target sector comprising two or more segments, the two or more segments may be determined to have the same width, and the width of the two or more segments may correspond to a power of 2.

The one or more processors may be configured to generate a first look-up table (LUT) comprising mapping information on which a sector among the plurality of sectors may include an input value in response to the input value being input to the non-linear function.

The one or more processors may be configured to generate a plurality of second look-up table (LUTs) corresponding one-to-one to the plurality of sectors, wherein each of the plurality of second LUTs may include a difference between a start function value and an end function value of a linear function approximated for each of one or more segments comprised in a sector corresponding to each second LUT and mapping information on the start function value.

The electronic device may include: a hardware processing module comprising: a first multiplexer (MUX) configured to select any one second LUT output value from among a plurality of second LUT output values of the second LUTs and output the selected second LUT output value, based on a first LUT output value of a first LUT comprising mapping information on which sector among a plurality of sectors into which an input range for the non-linear function is divided may include the input value; a second MUX configured to select and output a length from an x coordinate of the input value to a start x coordinate of a segment comprising the input value, based on the first LUT output value; and an arithmetic module configured to generate the output value based on an out of the first MUX and an output of the second MUX.

In one or more general aspects, an electronic device includes: a host processor configured to control a hardware processing module to input an input value and generate an output value to which a non-linear function is approximated; and the hardware processing module that is controlled by the host processor and configured to generate the output value in response to an input of the input value, wherein the hardware processing module may include: a first multiplexer (MUX) configured to select any one second look-up table (LUT) output value from among a plurality of second LUT output values and output the selected second LUT output value, based on a first LUT output value comprising mapping information on which a sector among a plurality of sectors into which an input range for the non-linear function is divided may include the input value; a second MUX configured to select and output a length from an x coordinate of the input value to a start x coordinate of a segment comprising the input value, based on the first LUT output value; and an arithmetic module configured to generate the output value based on an out of the first MUX and an output of the second MUX.

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of linear approximation of a non-linear function.

FIG. 3 illustrates an example of an algorithm for determining sectors and segments to linearly approximate a non-linear function.

FIG. 4 illustrates an example of determined sectors and segments of a Gaussian kernel.

FIG. 5 illustrates an example of a linear approximation result of a non-linear function.

FIG. 6 illustrates an example of sectors and segments of a logarithmic function.

FIG. 7 illustrates an example of different bit use by each sector.

FIG. 8 illustrates an example of a first look-up table (LUT).

FIG. 9 illustrates an example of a second LUT.

FIG. 10 illustrates an example of a hardware processing unit using a first LUT and a second LUT.

FIG. 11 illustrates an example of a method of approximating a non-linear function.

FIG. 12 illustrates an example of a method of determining a width of a target sector and a width of one or more segments included in the target sector.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

The phrases “at least one of A, B, and C,” “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, embodiments will be described in detail with reference to the accompanying drawings. When describing the embodiments with reference to the accompanying drawings, like reference numerals refer to like elements and a repeated description related thereto will be omitted.

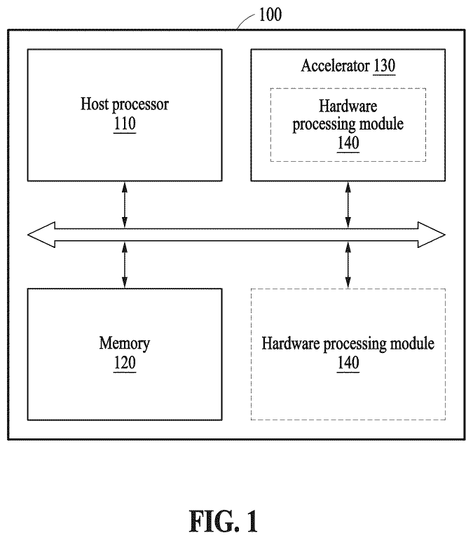

FIG. 1 illustrates an example of an electronic device.

Referring to FIG. 1, an electronic device 100 may include a host processor 110 (e.g., one or more processors), a memory 120 (e.g., one or more memories), and an accelerator 130. The host processor 110, the memory 120, and the accelerator 130 may communicate with one another through a bus, a network on a chip (NoC), and/or a peripheral component interconnect express (PCIe). Components related to embodiments herein are included in the electronic device 100 illustrated in FIG. 1. Thus, the electronic device 100 may also include other general-purpose components in addition to the components illustrated in FIG. 1.

The host processor 110 may perform overall functions for controlling the electronic device 100. The host processor 110 may generally control the electronic device 100 by executing programs and/or instructions stored in the memory 120. The host processor 110 may be implemented as a central processing unit (CPU), a graphics processing unit (GPU), or an application processor (AP), which is included in the electronic device 100, but examples are not limited thereto.

The memory 120 may be hardware for storing data having been processed or to be processed in the electronic device 100. In addition, the memory 120 may store an application or a driver to be driven by the electronic device 100. The memory 120 may include a volatile memory (e.g., dynamic random-access memory (DRAM)) and/or a non-volatile memory. In an example, the memory 120 may be or include a non-transitory computer-readable storage medium storing instructions that, when executed by the host processor 110, configure the host processor 110 perform any one, any combination, or all of operations and methods of the host processor 110 described herein with reference to FIGS. 1-12.

The electronic device 100 may include the accelerator 130 for an operation. A separate dedicated processor, that is, the accelerator 130, may more efficiently process an operation, due to the characteristics of the operation, than the general-purpose host processor 110. In an example, one or more processing elements (PEs) included in the accelerator 130 may be used. The accelerator 130 may correspond to, for example, a neural processing unit (NPU), a tensor processing unit (TPU), a digital signal processor (DSP), a GPU, and/or a neural engine, which performs an operation according to a neural network.

The electronic device 100 may perform image signal processing. The electronic device 100 may improve the quality of an image by removing noise from the image through an image signal processing pipeline. The image signal processing pipeline may include various filters for removing noise from the image. These various filters may use a non-linear function. Accordingly, an operation of the non-linear function may be used for image signal processing. To efficiently process the operation of the non-linear function, hardware for performing the operation of the non-linear function may be implemented. The accelerator 130 may include a hardware processing module 140 for performing the operation of the non-linear function. The hardware processing module 140 may be hardware for performing the operation of the non-linear function. To configure the hardware processing module 140, linear approximation may be first performed on the non-linear function of which the operation will be performed by the hardware processing module 140. The hardware processing module 140, depending on its purpose, may be included in the accelerator 130 or as a separate device in the electronic device 100.

A processor to be described below may be implemented as the accelerator 130, but examples are not limited thereto. The processor may also be implemented as the host processor 110.

The processor may determine an input range of the non-linear function to be a first width, which is a minimum width of a sector. The processor may determine a plurality of second widths, which is a basis for dividing each of a plurality of sectors into one or more segments. The processor may divide the non-linear function into the plurality of sectors including the one or more segments, based on the first width and the plurality of second widths. The processor may determine a use range of an input bit representing an input value for each of the plurality of sectors. A bit use range may include two or more among a sector determiner indicating which sector among the plurality of sectors includes an input value, a segment determiner indicating which segment among the one or more segments includes the input value, and an x-coordinate determiner indicating the x coordinate of the input value. The processor may generate look-up tables (LUTs) based on the bit use range. The hardware processing module 140 may be configured based on the sectors, segments, and LUTs with respect to the non-linear function.

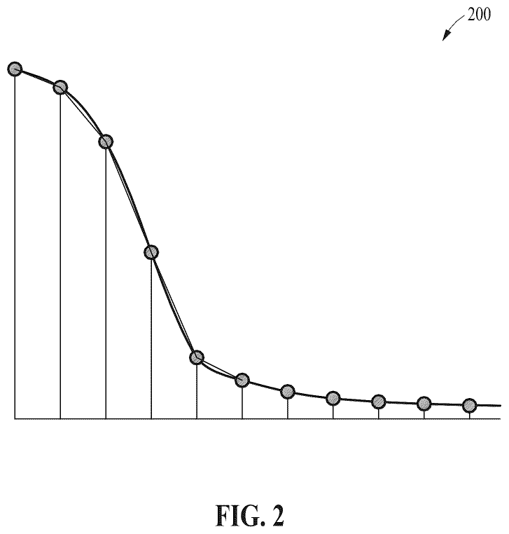

FIG. 2 illustrates an example of linear approximation of a non-linear function.

FIG. 2 illustrates a non-linear function 200. There may be various methods of approximating the non-linear function 200. Piecewise linear approximation among the methods may be a method of approximating the non-linear function 200 to multiple linear functions. When approximated to the multiple linear functions through the piecewise linear approximation, the non-linear function 200 may be converted into a simple and operable form. For example, an input range of the non-linear function 200 may be divided into multiple sections having the same width. The non-linear function 200 may be approximated to a straight line, which is a linear function, in each of the multiple sections. In an example, the accuracy of approximation may increase as the width of the sections decreases, and the accuracy of approximation may decrease as the width of the sections increases.

Hereinafter, an example of the method of dividing a non-linear function into sections having a width of powers of 2 and based on said piecewise linear approximation is described.

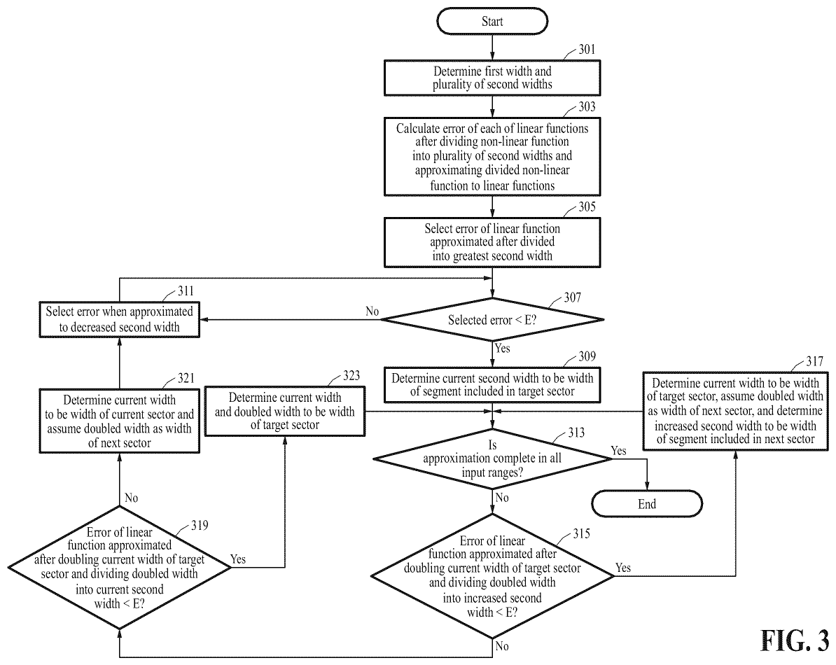

FIG. 3 illustrates an example of an algorithm for determining sectors and segments to linearly approximate a non-linear function.

In the following embodiments, operations may be performed sequentially, but may not be necessarily performed sequentially. For example, the order of the operations may be changed and at least two of the operations may be performed in parallel.

In operation 301, a processor may determine a first width and a plurality of second widths. The first width may be a minimum width of a sector, which is a basis for dividing an input range of the non-linear function into a plurality of sectors. The plurality of second widths may be a width that is a basis for dividing each of the plurality of sectors into one or more segments. The first width and the plurality of second widths may be determined in the unit of a power of 2. The plurality of second widths may be less than or equal to the first width. For example, the first width may be 1024, which is 2¹⁰, and the plurality of second widths may be determined to be 1024, 512, 256, 128, or 64.

In operation 303, the processor may determine an error of each of linear functions in response to dividing the non-linear function into the plurality of second widths and approximating the divided non-linear function to the linear functions. For example, the processor may determine an error of a linear function in response to dividing the non-linear function into the width of 1024 (which is one of the plurality of second widths) and approximating the divided non-linear function to the linear function. For another example, the processor may determine an error of a linear function in response to dividing the non-linear function into a width of 512 (which is one of the plurality of second widths) and approximating the divided non-linear function to the linear function. It will be appreciated after an understanding of the present disclosure that the method of determining an error of an approximated linear function could be achieved by using various known methods.

In operation 305, the processor may select an error of a linear function approximated in response to the non-linear function being divided into a greatest second width. For example, the processor may select an error of a linear function approximated in response to the non-linear function being divided into a width of 1024, which is the greatest second width.

In operation 307, the processor may determine whether the selected error is less than a preset error E. When operation 307 is performed in response to operation 305, the processor may compare the error of the linear function approximated in response to the non-linear function being divided into the greatest second width with the preset error E. When the selected error is greater than or equal to the preset error E, in operation 311, the processor may select an error of a linear function approximated in response to the non-linear function being divided into a decreased second width (e.g., a second width that is less than the greatest second width). When operation 307 is performed in response to operation 311, the processor may compare the error when approximated to the decreased second width with the preset error E. When the selected error is less than the preset error E, operation 309 may be performed. When the selected error is greater than or equal to the preset error E, operation 311 may be performed. For example, when the error of the linear function approximated in response to being divided into the greatest second width of 1024 is greater than the preset error E, operation 311 may be performed, an error of a linear function approximated to a decreased second width of 512 may be selected in operation 311, and operation 307 may be performed again. When the error of the linear function approximated to the decreased second width of 512 is greater than the preset error E, operation 311 may be performed, and an error of a linear function approximated to a decreased second width of 256 may be selected in operation 311.

In operation 309, the processor may determine the current second width (e.g., the second width corresponding to the selected error compared in operation 307) to be the width of a segment included in a target sector. The second width used to divide the non-linear function to have an error less than the preset error in operation 307 may be determined to be the width of the segment included in the target sector. For example, when an error of a linear function to which the non-linear function is divided into a second width of 256 and is approximated is less than the preset error E, 256 may be determined to be the width of the segment. Although the width of the segment is determined in operation 309, the width of the target sector including the segment is not determined yet. Accordingly, the width of the target sector may be determined hereinafter.

In operation 313, the processor may determine whether the approximation is complete in all input ranges. When the approximation is complete in all input ranges of the non-linear function, the processor may terminate the approximation of the non-linear function. When the approximation is not complete in all the input ranges of the non-linear function, the processor may perform operation 315.

In operation 315, the processor may determine whether an error of a linear function approximated in response to doubling the current width of the target sector and dividing an extended width (determined based on the doubling of the current width) into an increased second width is less than the preset error E. The increased second width may be greater than the second width determined to be the width of the segment in operation 309. The width of the target sector may be the same as the first width when the target sector is a first sector. The processor may perform operation 317 when satisfying operation 315. The processor may perform operation 319 when failing to satisfy operation 315.

For example, the processor may double the first width of 1024, may determine an error of a linear function approximated in response to dividing the extended width (here, 0 to 1024 is the current width, and 1024 to 2048 is the extended width) into 512 or 1024, which is a greater width than the second width of 256 determined to be the width of the segment in operation 309, and may determine whether the error is less than the preset error.

In operation 317, the processor may determine the current width to be the width of the target sector, may assume the extended width as the width of the next sector, and may determine the increased second width to be the width of a segment included in the next sector. For example, the current width of 1024 (e.g., 0 to 1024) is determined to be the width of the target sector, the extended width of 1024 (e.g., 1024 to 2048) may be assumed to be the width of the next sector, and 512 or 1024 that is greater than the current second width may be determined to be the width of the segment. (However, when there are two or more increased second widths, a width satisfying an error condition among them may be determined to be the width of the segment included in the next sector.) When the width of the target sector is determined in operation 317, the width of the target sector and the width of the one or more segments included in the target sector may all be determined. Accordingly, because the width of the next sector is to be determined, the target sector in operations 315 and 319 performed in response to operation 317 may refer to the next sector of which the width is assumed in operation 317. For example, when the width of the first sector is determined in operation 317, the target sector in operations 315 and 319 performed in response to operation 317 may refer to a second sector.

In operation 319, the processor may determine whether an error of a linear function approximated in response to doubling the current width of the target sector and dividing the extended width into the current second width is less than the preset error E. The current second width may be the determined width of the segment. The processor may perform operation 323 when satisfying operation 319. The processor may perform operation 321 when failing to satisfy operation 319.

In operation 321, the processor may determine the current width to be the width of the current sector and may assume the extended width as the width of the next sector. For example, the current width of 1024 (e.g., 0 to 1024) may be determined to be the width of the current sector, and the extended width of 1024 (e.g., 1024 to 2048) may be assumed as the width of the next sector.

Operation 311 performed in response to operation 321 may be an operation to determine the width of the segment included in the next sector. Accordingly, since it is determined that the current second width does not satisfy an error condition for the next sector in operation 319, the processor may select a decreased second width than the current width for the next sector in operation 311 in response to operation 321.

In operation 323, the processor may determine the current width and the extended width to be the width of the target sector. For example, the current width of 1024 (e.g., 0 to 1024) and the extended width of 1024 (e.g., 1024 to 2048) may be determined to be the width of the current sector.

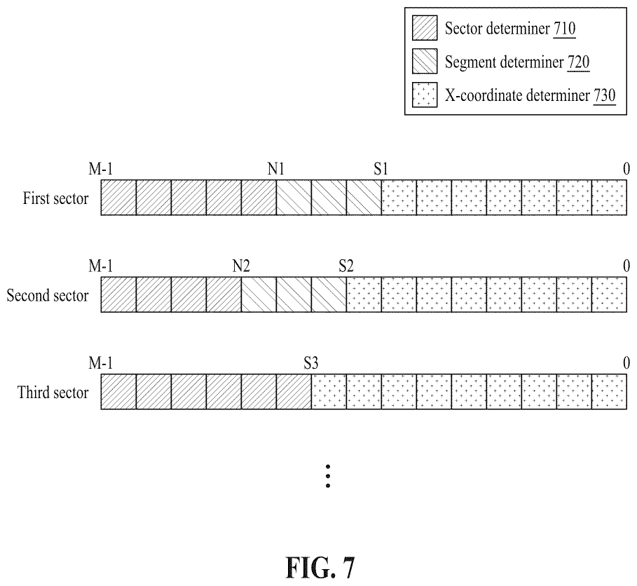

The non-linear function may be divided into the plurality of sectors each including the one or more segments through operations 301 and 323 described above. The width of a sector and the width of a segment may be allocated in the unit of a power of 2 in the method described above. In other words, the non-linear function may be divided into the unit of a power of 2 and approximated. As the width of a sector and the width of a segment are allocated in the unit of a power of 2, a bit use range for an input value for each of the plurality of sectors may vary, an example of which is described with reference to FIG. 7.

Hereinafter, an example of a result of applying said method to a Gaussian kernel function that is the non-linear function is described.

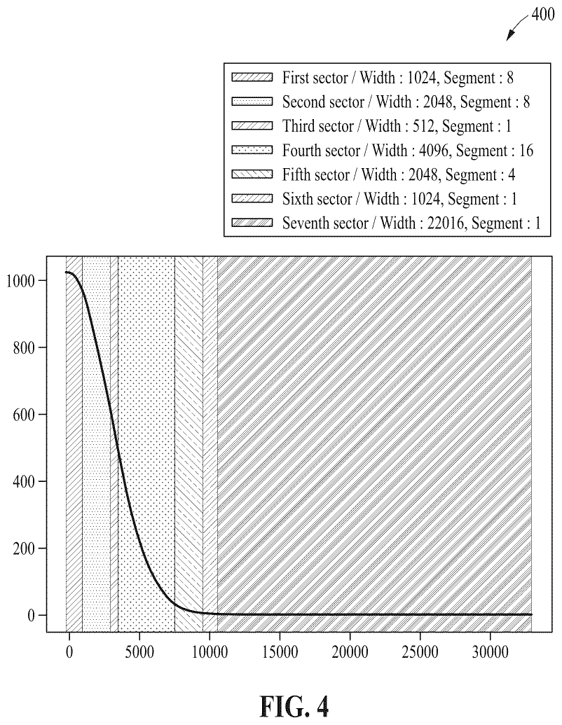

FIG. 4 illustrates an example of determined sectors and segments of a Gaussian kernel.

FIG. 4 illustrates a Gaussian kernel 400 divided into a plurality of sectors and one or more segments included in the plurality of sectors according to the method of FIG. 3. Referring to FIG. 4, the Gaussian kernel 400 may be divided into 7 sectors according to the method of FIG. 3. In FIG. 4, it is assumed that the Gaussian kernel 400 may generate an 11-bit output value in response to receiving a 15-bit input value.

A first sector may include 8 segments. The width of the first sector may be 1024, and the width of each segment may be 128.

A second sector may include 8 segments. The width of the second sector may be 2048, and the width of each segment may be 256.

A third sector may include 1 segment. The width of the third sector may be 512, and the width of the segment included in the third sector may be 512. When the number of a segment included in a sector is 1, the width of the sector may be the same as the width of the segment.

A fourth sector may include 16 segments. The width of the fourth sector may be 4096, and the width of each segment may be 256.

A fifth sector may include 4 segments. The width of the fifth sector may be 2048, and the width of each segment may be 512.

A sixth sector may include 1 segment. The width of the sixth sector may be 1024, and the width of the segment may be 1024.

A seventh sector may include 1 segment. The width of the seventh sector may be 22016, and the width of the segment may be 22016.

Accordingly, the Gaussian kernel 400 may be divided into a total of 39 segments, and each of the total of 39 segments may be approximated to a linear function. However, it will be appreciated after understanding of the present disclosure that this may vary depending on a first width, a plurality of second widths, and a preset error value.

The width of each sector may be a power of 2. The width of a segment may be a power of 2. Each sector may include the number of segments corresponding to a power of 2. The width of two or more segments included in the same sector may be the same. When a sector includes only one segment, the width of the sector may be the same as the width of the segment. However, the width of a last sector (e.g., the seventh sector) and a segment of the last sector may not be a power of 2. This may be because of the assumption that the non-linear function receives the 15-bit input value.

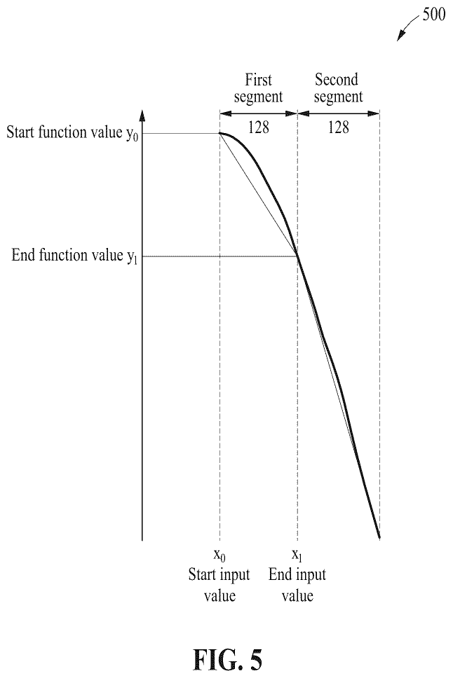

FIG. 5 is a diagram 500 illustrating a linear approximation result of a non-linear function.

The non-linear function may be divided into segments included in a plurality of sectors, and each of the segments may be approximated to a linear function. FIG. 5 is an enlarged view of a portion of the first sector of the Gaussian kernel 400 of FIG. 4. Hereinafter, an example of a straight line approximated by using a first segment of the first sector is described. However, it will be appreciated after an understanding of the present disclosure that the description to be provided below also applies to other segments included in other sectors.

The width of the first segment may be 128 as described above with reference to FIG. 4. A start input value may be x₀ in the first segment. An end input value may be x₁ in the first segment. A start function value corresponding to the start input value may be y₀ (that is, f(x₀)). An end function value corresponding to the end input value may be y₁ (that is, f(x₁)). Accordingly, the Gaussian kernel in the first segment may be approximated according Equation 1 below, for example.

### Equation 1:

$$( y - {y}_{0} ) = \frac{{y}_{1} - {y}_{0}}{{x}_{1} - {x}_{0}} ( x - {x}_{0} )$$

Hereinafter, an example of a result of applying the method of FIG. 3 to a logarithmic function, which is one of various embodiments, is described.

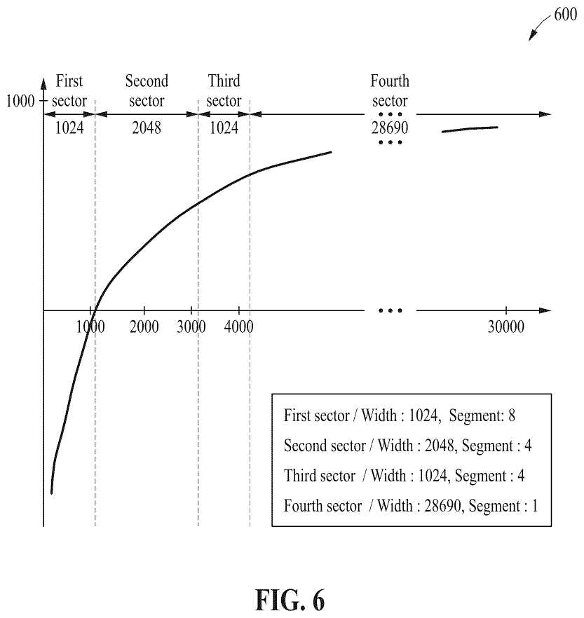

FIG. 6 illustrates an example of sectors and segments of a logarithmic function.

FIG. 6 illustrates a logarithmic function 600 divided into a plurality of sectors including one or more segments according to the method of FIG. 3. In an example, like FIG. 4, it is assumed that the logarithmic function 600 may generate an 11-bit output value in response to receiving a 15-bit input value.

A first sector may include 8 segments. The width of the first sector may be 1024, and the width of each segment may be 128.

A second sector may include 4 segments. The width of the second sector may be 2048, and the width of each segment may be 512.

A third sector may include 4 segments. The width of the third sector may be 1024, and the width of the segment included in the third sector may be 256.

A fourth sector may include 1 segment. The width of the fourth sector may be 28690, and the width of the segment may be 28690.

The widths of segments included in the same sector may be the same. For example, the width of 4 segments included in the third sector may be the same as 256. The widths of segments included in a sector may be different from the widths of segments included in a sector adjacent to the sector. For example, the width of 8 segments included in the first sector may be 128, and it may be different from the width of 4 segments included in the second sector adjacent to the first sector, which is 256.

Accordingly, the logarithmic function 600 may be divided into a total of 17 segments, and each of the total of 17 segments may be approximated to a linear function. However, it will be appreciated after an understanding of the present disclosure that this may vary depending on a first width, a plurality of second widths, and a preset error value.

It will be appreciated after an understanding of the present disclosure that a non-linear function, such as an exponential function or a square function, other than the Gaussian kernel 400 of FIG. 4 and the logarithmic function 600 of FIG. 6, may be divided into a plurality of sectors including one or more segments in the method of FIG. 3.

FIG. 7 illustrates an example of different bit use by each sector.

FIG. 7 illustrates a bit use range in which each sector determined in FIG. 4 uses an input bit. However, only the bit use ranges of first to third sectors are illustrated for ease of description, and it will be appreciated after an understanding of the present disclosure that the description to be provided below may also apply to other sectors or linear functions to which other non-linear functions are approximated.

When an input value is input to a non-linear function, the input value may be input in a bit format. Hereinafter, the input value represented in the bit format may be referred to as an input bit. The input bit may include information on which sector the input value is included in, which segment the input value is included in, and where an x coordinate is positioned based on a start input value of a segment. However, this information may be identified only when the input bit is divided according to the feature of each sector. Accordingly, the input bit may be divided differently according to the feature of each sector to determine which sector the input value is included in, which segment the input value is included in, and where the x coordinate is positioned based on the start input value of the segment.

A range used to determine which sector the input bit is included in when the input bit is divided differently according to the feature of each sector may be referred to as a sector determiner 710.

A range used to determine which segment the input bit is included in when the input bit is divided differently according to the feature of each sector may be referred to as a segment determiner 720. The indices of the segment determiner 720 may be represented by N1, N2, or N3.

A range used to determine the length of the x coordinate where the input bit is positioned based on the start input value of the segment including the input bit when the input bit is divided differently according to the feature of each sector may be an x-coordinate determiner 730. The indices of the x-coordinate determiner 730 may be represented by S1, S2, or S3.

When the Gaussian kernel 400 receives the 15-bit input bit in FIG. 4, the input bit may be determined to be 15 bits, and thus M=15.

First, referring to FIG. 4, the first sector may have the width of 1024 (0 to 1024) and may include 8 (2³) segments. The width of the segment included in the first sector may be 1024/8, which is 128 (2⁷). Accordingly, whether the first sector includes the input bit may be determined only by checking whether the input bit exceeds 1024. To determine whether the input bit exceeds 1024, the upper 11 bits or more in the input bit may be determined without needing to determine the lower 10 bits in the input bit. Accordingly, 15 to 11 bits may be determined to be the sector determiner 710 in the first sector. In addition, since the width of the segment is 128, the length of the x coordinate where the input bit is positioned in the segment including the input bit may be determined with the lower 7 bits of the input bit without needing to determine remaining bits in the input bit. Accordingly, 1 to 7 bits may be determined to be the x-coordinate determiner 730. Three bits may be used to determine which of the 8 segments the input bit is included in. Accordingly, 10 to 8 bits may be determined to be the segment determiner 720.

For example, an input value “800” included in the first sector and in the seventh segment in the first sector may be expressed by a 15-bit input bit as “0 0 0 0 0 1 10 0 10 0 0 0 0”. According to the description provided above, the sector determiner 710 may be “0 0 0 0 0”, the segment determiner 720 may be “1 1 0”, and the x-coordinate determiner 730 may be “0 1 0 0 0 0 0”. Accordingly, when the 15 to 11 bits are “0 0 0 0 0”, the input bit may be determined to be included in the first sector. The input bit of which the 10 to 8 bits are “1 1 0” may be determined to be included in the seventh segment. A section of the seventh segment may be [768, 896], the start input value may be 768, and the end input value may be 896. Since a decimal number into which the 1 to 7 bits of “0 100000” of the input bit are converted is 32, “800” may be determined to be 32 away from the start input value of 768 of the seventh segment.

Likewise, the second sector may have the width of 2048 (1024 to 3072) and may include 8 (2³) segments. The width of the segment included in the second sector may be 2048/8, which is 256 (2⁸). Accordingly, whether the second sector includes the input bit may be determined only by checking whether the input bit exceeds 2048, which is the width of the second sector. To determine whether the input bit exceeds 2048, only the upper 12 bits or more may be used. Accordingly, 15 to 12 bits may be determined to be the sector determiner 710 in the second sector. In addition, since the width of the segment is 256, the length of the x coordinate where the input bit is positioned in the segment including the input bit may use only the lower 8 bits of the input bit. Accordingly, 1 to 8 bits may be determined to be the x-coordinate determiner 730. Three bits may be used to determine which of the 8 segments the input bit is included in. Accordingly, 11 to 9 bits may be determined to be the segment determiner 720.

For example, an input value “1500” included in the second sector and in the second segment in the second sector may be expressed by a 15-bit input bit “0000 1011101110 0”. According to the description provided above, the sector determiner 710 may be “0 0 0 0”, the segment determiner 720 may be “1 0 1”, and the x-coordinate determiner 730 may be “1 1 0 1 1 0”. Accordingly, when the 15 to 12 bits are “0 0 0 0”, the input bit may be determined to be included in the second sector. The input bit of which the 11 to 9 bits are “1 0 1” may be determined to be included in the second segment. A section of the second segment may be [1280, 1536], the start input value may be 1280, and the end input value may be 1536. Since a decimal number into which the 1 to 8 bits of “1 1 0 1 1 10 0” of the input bit are converted is 220, “1500” may be determined to be 220 away from the start input value of 1280 of the second segment.

Likewise, the third sector may have the width of 512 (3072 to 3584) and may include 1 (2⁰) segment. In other words, the third sector may include the first segment only. The width of the segment included in the third sector may be 512 (2⁹), which may be the same as the width of the third sector. Accordingly, whether the third sector includes the input bit may be determined only by checking whether the input bit exceeds 512, which is the width of the third sector. To determine whether the input bit exceeds 512, only the upper 10 bits or more may be used. Accordingly, 15 to 10 bits may be determined to be the sector determiner 710 in the third sector. In addition, since the width of the segment is 512, the length of the x coordinate where the input bit is positioned in the segment including the input bit may use only the lower 9 bits of the input bit. Accordingly, 1 to 9 bits may be determined to be the x-coordinate determiner 730. Since the number of segments included in the third sector is 1, the segment determiner 720 may not be determined for the third sector.

For example, an input value “3200” included in the third sector may be expressed by a 15-bit input bit as “0 00 1 100 1000000 0”. According to the description provided above, the sector determiner 710 may be “0 0 0 1 1 0”, and the x-coordinate determiner 730 may be “0 1 0 000000”. Accordingly, when the 15 to 10 bits are “0 0 0 1 10”, the input bit may be determined to be included in the third sector. A section of the first segment may be [3072, 3584], the start input value may be 3072, and the end input value may be 3584. Since a decimal number into which the 1 to 9 bits of “0 10000000” of the input bit are converted is 128, “3600” may be determined to be 128 away from the start input value of 3072 of the second segment.

For the remaining sectors, the sector determiner 710, the segment determiner 720, and the x-coordinate determiner 730 may be determined according to the method described above. For a hardware processing module to efficiently generate an output value, which sector includes an input value expressed by an input bit may be immediately determined. In addition, for the hardware processing module to efficiently generate the output value, which segment of the sector includes the input value and the start function value and the end function value in that segment may be immediately determined. Accordingly, to this end, an LUT using the bit use range of each sector described above may be used. Hereinafter, an example of the method of a processor generating the LUT by using the bit use range of each sector is described.

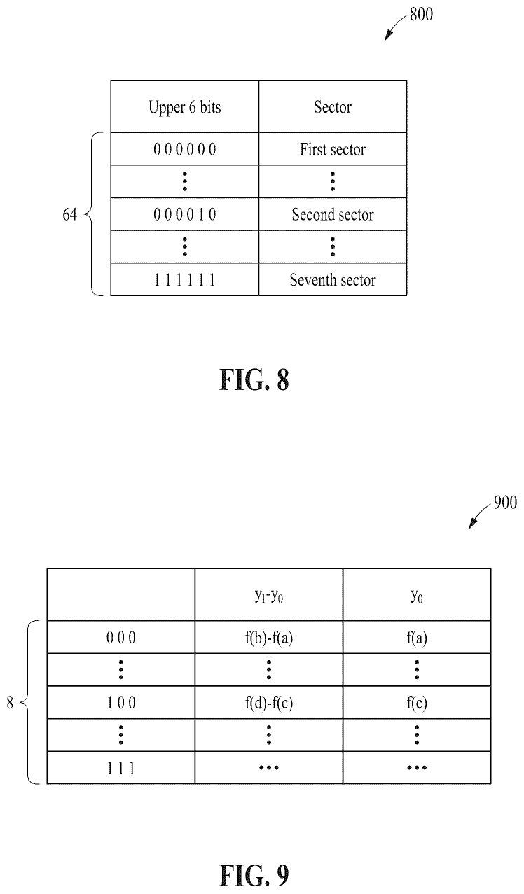

FIG. 8 illustrates an example of a first LUT.

Referring to FIG. 7, a bit use range of each sector may vary. Accordingly, which sector an input value expressed by an input bit is included in may be first determined by a hardware processing module by using an LUT. The LUT including mapping information on which sector the input value expressed by the input bit is included in among a plurality of sectors may be the first LUT.

As described above with reference to FIG. 7, which sector the input value expressed by the input bit is included in among the plurality of sectors may be determined by a sector determiner. However, as described above with reference to FIG. 7, the sector determiner used by each sector may vary. When the LUT is generated based on the sector determiner of a sector having the longest sector determiner, one LUT for all sectors may be generated.

FIG. 8 illustrates a first LUT 800 for the Gaussian kernel 400 of FIG. 4. In the Gaussian kernel 400 of FIG. 4, the sector having the longest sector determiner may be a third sector having the shortest width. Since the third sector has the sector determiner of upper 6 bits, a first value column of the first LUT 800 for the Gaussian kernel 400 of FIG. 4 may be expressed by 6 bits and may include all bits. A second value column may include mapped sector information which an input value having the upper 6 bits belongs to. In other words, the first LUT 800 may include mapping information to which the sector information including possible combinations (2⁶=64) of the upper 6 bits of the input bit and the input bit including the upper 6 bits is mapped.

For example, since “800” included in a first sector may be expressed by 15 bits as “0 0 0 0 0 1 100 100000”, the upper 6 bits “0 0 0 0 0 1” may be mapped to the first sector. Since “10” included in the first sector may be expressed by 15 bits as “000 00000000 10 10”, the upper 6 bits “0 0 0 0 0 0” may be mapped to the first sector. Since “1500” included in a second sector may be expressed by 15 bits as “0000 10 1 11011100”, the upper 6 bits “0 0 0 0 1 0” may be mapped to the second sector.

Hereinafter, an example of a second LUT including a difference between a start function value and an end function value of a linear function approximated for each of one or more segments in a sector and mapping information on the start function value is described.

FIG. 9 illustrates an example of a second LUT.

A processor may generate a plurality of second LUTs corresponding one-to-one to a plurality of sectors. Each of the plurality of second LUTs may include a difference between a start function value and an end function value of a linear function approximated for each of one or more segments included in a sector corresponding to each second LUT and mapping information on the start function value. When generating a second LUT, unlike when generating a first LUT, a segment determiner of each sector may be used. Accordingly, the second LUT may receive, as an input, bits corresponding to the segment determiner of a sector to which an input value belongs and may output a difference between a start function value and an end function value of the segment to which the input value belongs and the start value function.

FIG. 9 illustrates a second LUT 900 of a first sector. Although the generation of the second LUT of the first sector is described hereinafter for ease of description, it will be appreciated after understanding of the present disclosure that the description below also applies to other sectors.

Referring to FIG. 4, since the input value “100” included in the first segment of the first sector may be expressed by 15 bits as “00000000 1 100 100”, and the segment determiner of the first sector may be determined to be 10 to 8 bits, in the input bit, bits corresponding to the segment determiner of the first sector may be “0 0 0”. “0 0 0” may be mapped to a difference between a start function value and an end function value of the first segment and the start function value. When a start input value of the first segment is a, and an end input value of the first segment is b, “0 0 0” may be mapped to f(b)-f(a) and f(a) Since the input value “300” included in a third segment of the first sector may be expressed by 15 bits as “00000 100 10 1 1000”, in the input bit, bits corresponding to the segment determiner of the first sector may be “1 0 0”. When a start input value of the third segment is c, and an end input value of the third segment is d, “1 0 0” may be mapped to f(d)-f(c) and f(c).

Hereinafter, an example of a hardware processing module for outputting an approximate value by using the first LUT and the plurality of second LUTs described above when an input value is input is described.

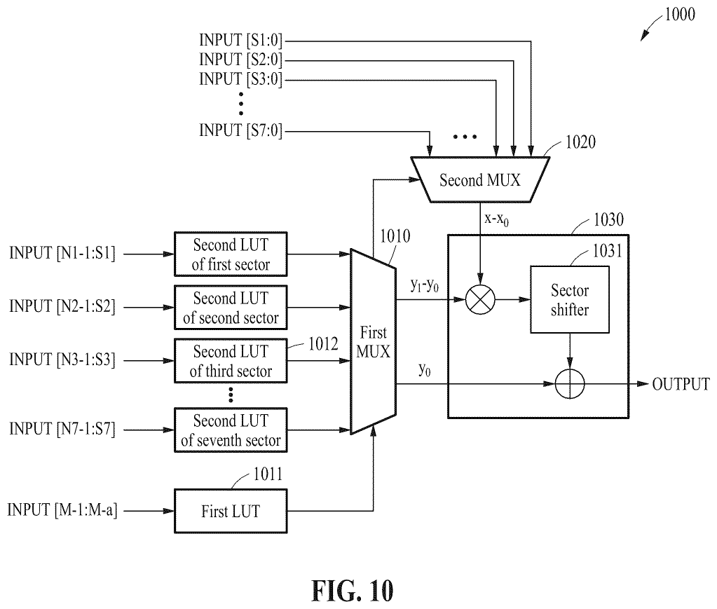

FIG. 10 illustrates an example of a hardware processing module using a first LUT and a second LUT.

A hardware processing module 1000 (e.g., the hardware processing module 140), which is a device for processing a non-linear function, may be a device for outputting an approximate value of a non-linear function approximated for each segment when an input value is input and is divided into sectors and the segments in the method described with reference to FIGS. 3 to 5.

The hardware processing module 1000 may be controlled by a host processor. The host processor may control the hardware processing module 1000 to input an input value and generate an output value to which a non-linear function is approximated.

The hardware processing module 1000 may include a first multiplexer (MUX) 1010, a second MUX 1020, and an arithmetic module 1030.

Hereinafter, the hardware processing module 1000 may be assumed to be a device for processing the Gaussian kernel 400 of FIG. 4.

When an input bit representing an input value is input to the hardware processing module 1000, the first MUX 1010 may select one from among a plurality of inputs, based on an output value of a first LUT 1011. The plurality of inputs to the first MUX 1010 may be an output value of a plurality of second LUTs.

The first LUT 1011 may receive, as an input, bits corresponding to an upper bit corresponding to the longest sector determiner in the input bit. That is, the first LUT 1011 may receive INPUT [M−1: M-a] as an input. Here, referring to FIG. 7, a may be 6, which is the length of the longest sector determiner, and M may be 15, which is the number of input bits that a non-linear function may receive.

The output of the first LUT 1011 relates to which sector the input bit is included in, and the first MUX 1010 may select an output of a second LUT corresponding to the sector in which the input bit is included. For example, when the input bit “0 0 0 1 100 1000000 0” representing the input value “3200” included in the third sector of the Gaussian kernel 400 of FIG. 4 is input to the hardware processing module 1000, the first LUT 1011 may receive, as an input, the upper 6 bits “0 0 0 1 1 0” and output the third sector mapped thereto. Accordingly, the first MUX 1010 may select the output (that is, y₁−y₀ and y₀) of the second LUT 1012 corresponding to the third sector. Here, y₁ may be an end function value of a segment including an input bit, and may be a start function value including the input bit.

Each of the second LUTs may receive, from the input bit, bits corresponding to the segment determiner of each of the sectors corresponding to the second LUTs and may output a value mapped to the bits.

The second MUX 1020 may receive the output of the first LUT 1011 from the first MUX 1010. Based on an output value of the first LUT 1011, the second MUX 1020 may select and output the length (that is, x−x₀) from the x-coordinate (x) of an input value to a start x-coordinate (x₀) of a segment including the input value. For example, the second MUX 1020 may select INPUT [S3:0].

The arithmetic module 1030 may generate an output value (that is, an approximate value) based on the output of the first MUX 1010 and the output of the second MUX 1020. The arithmetic module 1030 may multiply the difference (y₁−y₀) between the start function value and the end function value of the output of the first MUX 1010 by the length (x−x₀) from the x-coordinate of the input value to the start x-coordinate of the segment including the input value. Then, the arithmetic module 1030 may divide the multiplication result by x₁−x₀ by using a sector shifter 1031. Then, the arithmetic module 1030 may generate an output value (that is, an approximate value

$$\tilde{y} = \frac{( {y}_{1} - {y}_{0} ) * ( x - {x}_{0} )}{( {x}_{1} - {x}_{0} )} + {y}_{0} )$$

by adding a start function value (0) of the output of the first MUX 1010 to the division result.

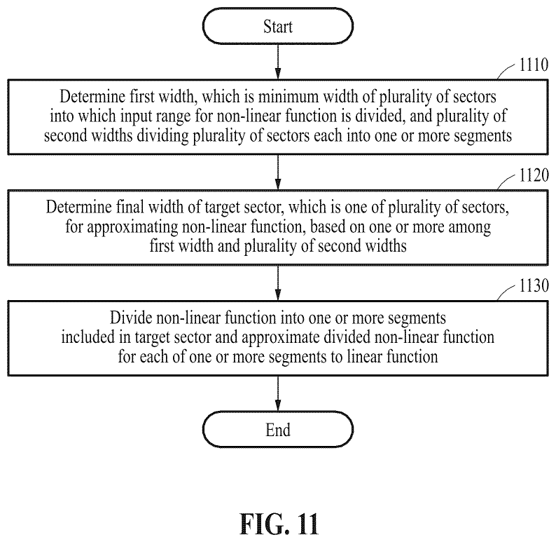

FIG. 11 illustrates an example of a method of approximating a non-linear function.

In the following embodiments, operations may be performed sequentially, but may not be necessarily performed sequentially. For example, the order of the operations may be changed and at least two of the operations may be performed in parallel.

In operation 1110, an electronic device may determine a first width, which is a minimum width of a plurality of sectors into which an input range for the non-linear function is divided, and a plurality of second widths dividing the plurality of sectors each into one or more segments.

In operation 1120, the electronic device may determine a final width of a target sector, which is one of the plurality of sectors, for approximating the non-linear function, based on one or more among the first width and the plurality of second widths.

In operation 1130, the electronic device may divide the non-linear function into one or more segments included in the target sector and may approximate the divided non-linear function for each of the one or more segments to a linear function.

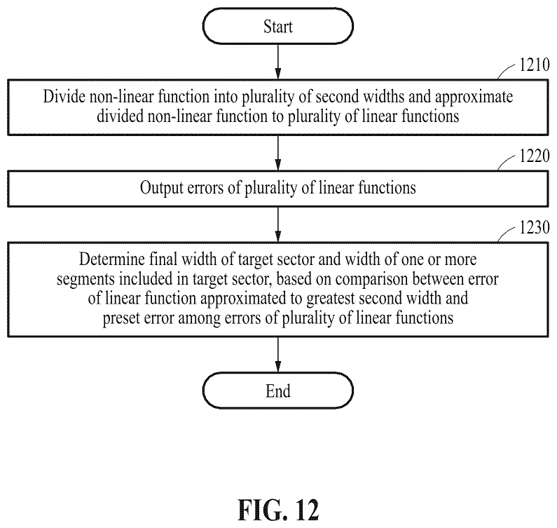

FIG. 12 illustrates an example of a method of determining a width of a target sector and a width of one or more segments included in the target sector.

In the following embodiments, operations may be performed sequentially, but may not be necessarily performed sequentially. For example, the order of the operations may be changed and at least two of the operations may be performed in parallel.

In operation 1210, an electronic device may divide a non-linear function into a plurality of second widths and may approximate the divided non-linear function to a plurality of linear functions.

In operation 1220, the electronic device may output errors of the plurality of linear functions.

In operation 1230, the electronic device may determine the final width of the target sector and the width of the one or more segments included in the target sector, based on the comparison between the error of the linear function approximated to the greatest second width and the preset error among the errors of the plurality of linear functions.

The electronic devices, host processors, memories, accelerators, hardware processing modules, first MUXs, second MUXs, arithmetic modules, sector shifters, electronic device 100, host processor 110, memory 120, accelerator 130, hardware processing module 140, hardware processing module 1000, first MUX 1010, second MUX 1020, arithmetic module 1030, sector shifter 1031, and other apparatuses, devices, units, modules, and components disclosed and described herein with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
determining a first width, the first width being a minimum width of a plurality of sectors into which an input range for a non-linear function is divided, and a plurality of second widths dividing the plurality of sectors each into one or more segments;
determining a final width of a target sector, the target sector being one of the plurality of sectors, for approximating the non-linear function, based on one or more among the first width and the plurality of second widths; and
dividing the non-linear function into one or more segments comprised in the target sector and approximating the divided non-linear function for each of the one or more segments to a linear function.

2. The method of claim 1, wherein the determining the final width of the target sector comprises:
determining the final width of the target sector to be a multiple of the first width; and
determining a width of the one or more segments comprised in the target sector to be one of the plurality of second widths.

3. The method of claim 1, wherein the determining the final width of the target sector further comprises:
dividing the non-linear function into the plurality of second widths and approximating the divided non-linear function to a plurality of linear functions;
determining errors of the plurality of linear functions; and
determining the final width of the target sector and the width of the one or more segments comprised in the target sector, based on a comparison between an error of a linear function approximated to a greatest second width among the plurality of second widths and a preset error among the errors of the plurality of linear functions.

4. The method of claim 3, wherein the determining the final width of the target sector and the width of the one or more segments comprised in the target sector, based on the comparison between the error of the linear function approximated to the greatest second width and the preset error among the errors of the plurality of linear functions, comprises determining the final width of the target sector and the width of the one or more segments to be greater as the preset error increases.

5. The method of claim 1, wherein the first width and the plurality of second widths are determined in a power of 2, and the plurality of second widths is determined to be less than or equal to the first width.

6. The method of claim 1, wherein the number of the one or more segments comprised in the target sector corresponds to a power of 2.

7. The method of claim 1, wherein, in response to the target sector comprising two or more segments, the two or more segments are determined to have a same width, and the width of the two or more segments corresponds to a power of 2.

8. The method of claim 1, further comprising generating a first look-up table (LUT) comprising mapping information on which a sector among the plurality of sectors comprises an input value in response to the input value being input to the non-linear function.

9. The method of claim 1, further comprising generating a plurality of second look-up tables (LUTs) corresponding one-to-one to the plurality of sectors,
wherein each of the plurality of second LUTs comprises a difference between a start function value and an end function value of a linear function approximated for each of one or more segments comprised in a sector corresponding to each second LUT and mapping information on the start function value.

10. A non-transitory computer-readable storage medium storing instructions that, when executed by one or more processors, configure the one or more processors to perform the method of claim 1.

11. An electronic device comprising:
one or more processors configured to:
determine a first width, the first width being a minimum width of a plurality of sectors into which an input range for a non-linear function is divided, and a plurality of second widths dividing the plurality of sectors each into one or more segments;
determine a final width of a target sector, the target sector being one of the plurality of sectors, for approximating the non-linear function, based on one or more among the first width and the plurality of second widths; and
divide the non-linear function into one or more segments comprised in the target sector and approximate the divided non-linear function for each of the one or more segments to a linear function.

12. The electronic device of claim 11, wherein, for the determining the final width of the target sector, the one or more processors are further configured to:
determine the final width of the target sector to be a multiple of the first width; and
determine a width of the one or more segments comprised in the target sector to be one of the plurality of second widths.

13. The electronic device of claim 11, wherein, for the determining the final width of the target sector, the one or more processors are further configured to:
divide the non-linear function into the plurality of second widths and approximate the divided non-linear function to a plurality of linear functions;
determine errors of the plurality of linear functions; and
determine the final width of the target sector and the width of the one or more segments comprised in the target sector, based on a comparison between an error of a linear function approximated to a greatest second width among the plurality of second widths and a preset error among the errors of the plurality of linear functions.

14. The electronic device of claim 11, wherein the first width and the plurality of second widths are determined in a power of 2, and the plurality of second widths is determined to be less than or equal to the first width.

15. The electronic device of claim 11, wherein the number of the one or more segments comprised in the target sector corresponds to a power of 2.

16. The electronic device of claim 11, wherein, in response to the target sector comprising two or more segments, the two or more segments are determined to have the same width, and the width of the two or more segments corresponds to a power of 2.

17. The electronic device of claim 11, wherein the one or more processors are further configured to generate a first look-up table (LUT) comprising mapping information on which a sector among the plurality of sectors comprises an input value in response to the input value being input to the non-linear function.

18. The electronic device of claim 11, wherein the one or more processors are further configured to generate a plurality of second look-up table (LUTs) corresponding one-to-one to the plurality of sectors,
wherein each of the plurality of second LUTs comprises a difference between a start function value and an end function value of a linear function approximated for each of one or more segments comprised in a sector corresponding to each second LUT and mapping information on the start function value.

19. The electronic device of claim 18, further comprising:
a hardware processing module comprising:
a first multiplexer (MUX) configured to select any one second LUT output value from among a plurality of second LUT output values of the second LUTs and output the selected second LUT output value, based on a first LUT output value of a first LUT comprising mapping information on which sector among a plurality of sectors into which an input range for the non-linear function is divided comprises the input value;
a second MUX configured to select and output a length from an x coordinate of the input value to a start x coordinate of a segment comprising the input value, based on the first LUT output value; and
an arithmetic module configured to generate the output value based on an out of the first MUX and an output of the second MUX.

20. An electronic device comprising:
a host processor configured to control a hardware processing module to input an input value and generate an output value to which a non-linear function is approximated; and
the hardware processing module that is controlled by the host processor and configured to generate the output value in response to an input of the input value, wherein the hardware processing module comprises:
a first multiplexer (MUX) configured to select any one second look-up table (LUT) output value from among a plurality of second LUT output values and output the selected second LUT output value, based on a first LUT output value comprising mapping information on which a sector among a plurality of sectors into which an input range for the non-linear function is divided comprises the input value;
a second MUX configured to select and output a length from an x coordinate of the input value to a start x coordinate of a segment comprising the input value, based on the first LUT output value; and
an arithmetic module configured to generate the output value based on an out of the first MUX and an output of the second MUX.
